(19) United States
(12) Patent Application Publication
(10) Pub. No.: US 2007/0209605 A1
(43) Pub. Date: Sep. 13, 2007

(54) Modular control and heater assembly

(75) Inventor: Raymond Joubran, Pasadena, CA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: Robertshaw Controls Company, Richmond, VA (US)

(21) Appl. No.: 11/346,794

(22) Filed: Feb. 3, 2006

(51) Int. Cl. F24H 9/20; H05B 3/00

(52) U.S. Cl. 122/14.2; 122/14.31; 126/116 A; 126/104 A; 29/611; 29/854

(57) ABSTRACT

The present invention involves a water heater and method of manufacturing the same. The water heater includes a tank assembly and a base assembly. The base assembly includes a heater assembly, a control unit, a control circuit and at least one temperature sensor. The base assembly is a separate module that has at least the heater assembly and control unit mounted thereto.

### BACKGROUND OF THE INVENTION

The invention relates generally to the area of water heaters. Water heaters generally comprise a water storage tank, a jacket and insulation around the tank, a heater assembly and a water inlet and water outlet. A source of energy may be supplied for heating either via a burnable fuel such as a hydrocarbon fuel like natural gas or propane or the energy may be supplied by electricity. Generally, hydrocarbon gas fueled water heaters have a heater assembly positioned adjacent a lower portion of the tank that selectively provides heat to the tank and the water in the tank.

The manufacture of a complete water heater, particularly those used in households, involves positioning a jacket around the tank and having insulation positioned between the jacket and the exterior of the tank. Such water heaters have a tank capacity of up to about 80 gallons. In the case of water heaters that use burning fuel as an energy source, the bottom of the tank is typically left exposed for heat supplied from the burning fuel to be transferred first convectively to the bottom wall of the tank and then conductively through the bottom wall of the tank to the water inside the tank. A typical electric water heater has resistance heating elements inserted into the tank interior through ports in the sidewall of the tank. The lower portion of the jacket may be used as a base in the case of a burner type water heater, for mounting a burner, a fuel control unit and a pilot burner into and/or onto.

Generally, the assembly of a burner type water heater involves handling the tank and jacket assembly while installing the various components that are used to supply the fuel and the burner, and the controller(s) for controlling the operation of the burner. The space for such assembly may be limited and also involves working with the tank and jacket pre-assembled. This requires significant space on an assembly line and also generally requires equipment to handle the tank assembly while installing the various heater and controller components. In some water heaters, the fuel control unit has an attached temperature sensor which may be mounted as an assembly with a fuel control unit to the tank assembly. Thereafter, the fuel control unit is attached to the burner and pilot. This whole process can be time consuming and expensive.

The present invention solves these problems by providing a pre-assembled modular control and heater assembly which requires simply setting a tank assembly, including tank, jacket and insulation, onto the base assembly and then connecting a water temperature sensor to the tank assembly.

### SUMMARY OF THE INVENTION

The present invention involves the provision of a modular control and heater assembly which is formed as a separate base assembly with components thereof pre-assembled before attachment to the tank assembly. An upper portion of the base assembly is adapted for having a tank assembly mounted thereon, which tank assembly will include a jacket, insulation and water tank. When the energy source is a burning fuel, a flue is provided which typically extends up through the tank to help exchange heat from the heated gases to the water in the tank. The base assembly has many of the components mounted thereto prior to mounting the tank assembly onto the base assembly facilitating assembly of the final water heater. The base assembly has mounted thereto the energy input control unit, at least certain components of a control circuit and the heater. The pre-assembled base assembly allows for easy assembly of major components of the water heater without having to manipulate the tank assembly for installation of parts separately.

The present invention also involves the provision of a method for assembling a water heater. The method involves forming a base assembly by attaching a heater to a base. A control unit is mounted to the base and is associated with the heater to control energy source input to the heater. A control circuit is connected to the control unit and is operable to provide a control signal to the control unit for selectively allowing energy source input to the heater. At least one temperature sensor is connected to components of the control circuit. After assembly of the base assembly, the water tank assembly is mounted to the base assembly and is in heat transfer relationship to the heater. A temperature sensor is positioned to provide an output indicative of water temperature in the water tank assembly which signal is received by components of the control circuit.

### BRIEF DESCRIPTION S OF THE DRAWING(S)

FIG. 1 is a perspective view of a water heater assembly with portions broken away to show internal details.

FIG. 2 is an enlarged perspective view of the base assembly.

FIG. 3 is a schematic illustration of a control circuit.

FIG. 4 is a second enlarged perspective view of the base assembly.

Similar numbers throughout the various drawings designate like or similar parts or structure.

### DETAILED DESCRIPTION OF THE INVENTION

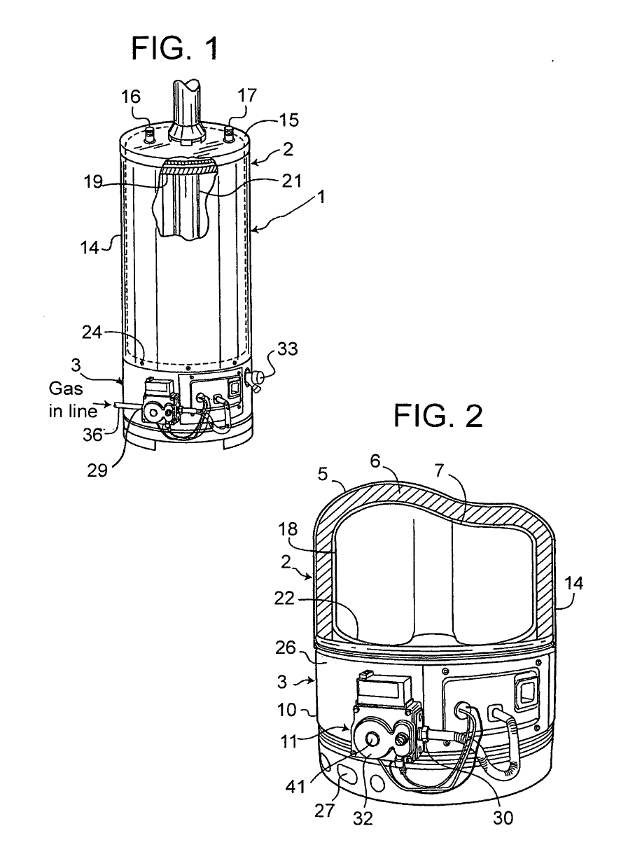

As best seen in FIG. 1, the water heater, designated generally 1, includes a tank assembly designated generally 2 and a base assembly designated generally 3. The water tank assembly typically includes a jacket 5 encasing insulation 6 which in turns at least substantially encapsulates a tank 7 to retard heat loss from the water in the tank 7. The base assembly 3 generally includes a support 10. A control unit 11 is mounted to the support 10 and is operable to control the input of energy for example, electricity or a burnable fuel to a heater assembly 12 for generating heat to heat the water in the tank 7 by one or more of conduction, convection, radiation and/or irradiation (e.g., microwave).

The water heater 1 includes the tank assembly 2. The tank assembly 2 includes the jacket 5 which is typically formed of a thin sheet of metal suitably coated for resistance to corrosion and for appearance. The jacket 5 may be formed in any suitable manner and comprises a sidewall 14 and cap 15. An inlet connection 16 and outlet connection 17 are provided typically by having couplings extend through the cap 15. The tank assembly 2 further includes a tank 7 having a sidewall 18 and cap 19 that are spaced from the sidewall 14 and cap 15 to provide a space or chamber for insulation 6. The insulation 6 may be of any suitable type such as a fiberglass mat or a temperature resistant foam. In the case of a burnable fuel heater water heater, a flue 21 is provided and is typically positioned at the center of the tank extending from the tank bottom 22 through the caps 15, 19. The flow of heated gas through the flue 21, can be used to heat water in the tank 7. A tank drain 33 may also be provided as is well known in the art. In the illustrated structure, the sidewall 14 terminates at a bottom end preferably adjacent the level of the bottom 22. In the case of a water heater using a burnable energy source, the bottom 22 is exposed for permitting heat transfer to the water through the bottom 22. The flue 21 is preferable generally centrally located and allows byproducts of combustion to flow upwardly to a venting system as is also well know in the art. The interior of the tank 7 may be lined to reduce corrosion as is also known in the art.

The base assembly 3 includes a generally upstanding wall 26 comprising at least a portion of the support 10. As illustrated, the wall 26 has an outer perimeter that is shaped generally similarly to the shape of the sidewall 14 adjacent the bottom 22. The wall 26 is adapted to have the tank assembly 2 mounted thereon as for example by the use of screw fasteners 24 in cooperating holes in the sidewall 14 of the tank assembly 2 and the wall 26 of the base assembly 3. A lower portion of sidewall 14 may, in an embodiment of the invention, extend downwardly over or within at least a portion of wall 26.

For those base assemblies using a burnable fuel for an energy source, air vents 27 through the wall 26 may be provided. In a preferred embodiment, the wall 26 is formed of a galvanized sheet metal which may also be painted. The base assembly 3 has mounted thereto the control unit 11 and heater assembly 12.

The control unit 11 is preferably mounted on the exterior of the wall 26 as for example with screw fasteners (not shown). By mounting the control unit 11 on the exterior of the wall 26, maintenance of the control unit 11 is made easier. In the case of a heater assembly 12 utilizing burnable fuel, the control unit 11 includes a fuel inlet 29 and a fuel outlet 30. In the water heater industry, when the fuel is a burnable fuel, the control unit is often called a fuel control unit and it includes a flow control valve arrangement in a body 32 and is operable to be selectively opened and closed to provide selective flow of fuel to a burner 34 and a pilot 35 which are components of the illustrated heater assembly 12. The heater assembly 12 may also, instead of being a fuel burner, provide heat through radiation or conduction, e.g., electrical resistance heaters placed the heat transfer relationship to the water in the tank 7 preferably adjacent the bottom 22 and the upper portion of the tank. Screw-in resistance heaters may be used as are known. Radiation heaters may include the type that is currently used in stove tops and ovens using light as an energy source. Magnetrons could also be used as an energy source by providing appropriate shielding and a microwave transmissive member to allow the microwave radiation to enter the tank 7.

In the illustrated structure, the heater assembly 12 includes a burner 34 with an associated pilot 35. Fuel is supplied from the control unit 11 from an energy source 36 such as a natural gas line or in the case of an electrically operated heater, an electrical feed line. When using a burner 34, a pilot 35 is used to ignite the burner as is well known in the art. A safety device is provided, to ensure that the pilot 35 is lit to provide a flame to the burner, before the flow control valve in the control unit 11 can be moved to an open position. Typically, a thermocouple 38 has a bimetallic junction and is positioned so that a portion thereof will sense the existence of a pilot flame 45 from the pilot 35. As is known in the art, and as is shown in U.S. Pat. No. 5,967,766, the entire disclosure of which is incorporated herein by reference, the flow control valve 44 in the control unit 11 is operated by an electromagnet 43 which in turn is energized by current from the thermocouple 38. The pilot may be intermittently operated by a spark ignition system which is also well known in the art. Prior to activating the heater assembly 12, a sensor assembly 40 provides a signal or indication that the water in the tank needs heat. Such sensors are well known in the art. Such a sensor may be a thermocouple which may be mounted in combination with a sensor 41 that expands with heat to operate a snap acting flow control valve 48.

The heat sensors 38 and 40 may be of a contact type or a non contact type senor and can be a bimetallic element, a thermocouple, as already disclosed, a resistance thermometer, a thermistor, a radiation or optical pyrometer, heat sensitive switch or a fluid expansion device such as a thermometer or a gas filled bulb all of which are well known temperature sensors and indicators. A thermocouple 38 operated by the pilot 35 has been found useful particularly when a burnable fuel is used since it can provide a current adequate to operate an electromagnet which in turn operates the infeed safety flow control valve in the control unit 11.

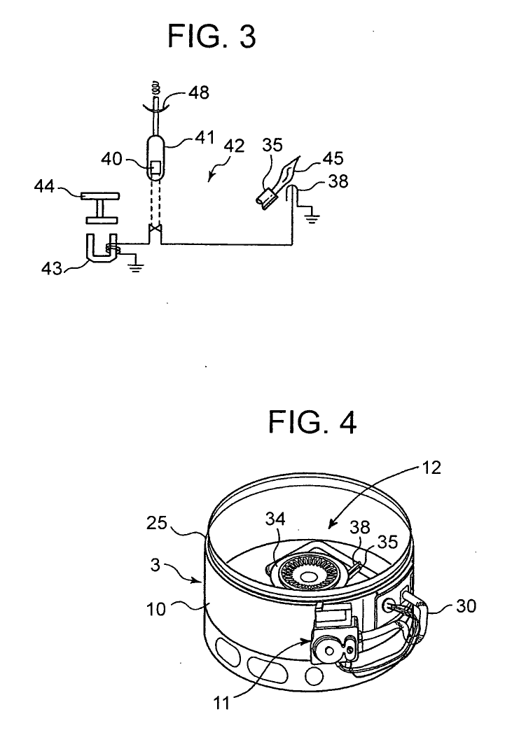

In overview, the sensors 38 and 40 are operatively coupled to a control circuit 42 as best seen in FIG. 3. For a fuel burner heat source, the control circuit will operate a fuel flow control valve 48. In the event energy is provided in the form of electricity, the control unit would include a switch instead of a valve to intermittently permit energy to be transferred to the heater assembly 12. In either event, at least one sensor assembly is needed to at least indicate the temperature of the water and a need for additional input of energy when the temperature falls below a pre-determined temperature. When a burnable fuel is used as the energy source, the pilot light will heat the thermocouple 38 and generate a current sufficient to activate an electromagnet which will in turn open the fuel control valve. However, for the control circuit 42 to work, the sensor assembly 40 needs to indicate that the water needs to be heated. The control circuit 42, when used with a burner type heater, will first receive a signal from the sensor 40 indicated that heat is needed and activate the pilot, if not already on, as for example through a spark ignition system. Once the thermocouple 38 is heated adequately to indicate that a pilot flame is in existence, the thermocouple 38 will energize the electromagnet 43 which in turn will open the fuel safety flow control valve 44 and an adjustable sensor 41 will open a burner fuel flow control valve 48 mechanically or electrically. Such circuits are well known in the art.

The present invention also involves the provision of a method of manufacturing a water heater as follows. The tank assembly 2 is formed by making an assembly of the jacket 5, insulation 6 and tank 7. In the method, first the base assembly 3 is formed or constructed after which the water tank assembly 2 is mounted to the base assembly. In the method of forming the modular assembly 3, the heater assembly 12 is mounted to support 10. The control unit 11 is also mounted to the support 10 and is operable to control the energy input to the heater usually in an off and on manner. The control unit is connected to the heater assembly 12 in a manner to control energy input to the heater assembly. A control circuit 42 is connected to the control unit and is operable to provide a control signal to the control unit 11 to turn the energy flow on or off and also, if desired proportion the flow of energy input per unit of time to the heater assembly 12. The control circuit 42 has a temperature sensor connected to components of the control circuit for operation of the control unit 11 by the control circuit. After the base assembly is formed, a water tank assembly 2 is mounted thereto in heat transfer relationship to the heater assembly 12 which has been mounted in to the support 10. A temperature sensor 40 such as a temperature sensitive switch is in heat transfer relationship to the tank and is preferably attached to the tank 7 in heat transfer relationship after the water tank assembly 2 is mounted to the modular heater assembly and selectively provides a control signal in control circuit 42. However, a temperature sensor 40 may be mounted to the tank 7 after the water tank assembly 2 is mounted to the base assembly 3 by connecting the temperature sensor 40 to components of the control circuit 42. The heat sensor 38 is preferably mounted adjacent to burner 34 during the formation process of the heater assembly 12. The energy conductor, for example electrical wires or a conduit is connected between the control unit 11 and heater assembly 12 to provide for the transfer of energy to the heater assembly. This connection step is performed prior to mounting the water tank assembly 2 to the base assembly 3. The heat sensor thermocouple 38 is positioned adjacent a pilot during the formation of a heater assembly 12 at a position to sense a pilot flame.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

1. A burner and controller assembly separate from and adapted for attachment to a water heater tank assembly to produce a water heater, said burner and controller assembly comprising:
a base support adapted to be but not mounted to a water heater tank;
a heater attached to the base support;
an energy control unit mounted to the base support and connected in energy transfer relation with the heater;
a temperature sensor and;
a control circuit carried by the base support and connecting the temperature sensor to the energy control unit

2. A burner and controller assembly as set forth in claim 1 wherein the temperature sensor includes a signal transfer device to transfer a signal from a sensor element to a component of the control circuit.

3. A burner and controller assembly as set forth in claim 2 including a safety shut-off associated with the burner operable to selectively prevent flow of energy to the heater.

4. A burner and controller assembly as set forth in claim 3 wherein said safety shut-off includes a pilot light sensor and the heater includes a burner.

5. A burner and controller assembly as set forth in claim 4 including a pilot light burner associated with the burner.

6. A burner and controller assembly as set forth in claim 5 wherein the pilot light sensor includes a pilot light thermocouple operable to generate current when exposed to a pilot light flame.

7. A burner and controller assembly as set forth in claim 6 wherein the energy control unit includes the fuel inlet valve and an electromagnet operably connected to the pilot light thermocouple and other components of the control circuit to selectively open and close the fuel inlet valve.

8. A burner and controller assembly as set forth in claim 2 wherein the temperature sensor is at least one of a bimetallic element, thermocouple, resistance thermometer, thermistor, radiation and optical pyrometer and a temperature operated expansion device.

9. A burner and controller assembly as set forth in claim 2 wherein the temperature sensor is operable to generate current in response to sensed temperature change.

10. A burner and controller assembly as set forth in claim 9 wherein the temperature sensitive switch includes a thermocouple.

11. A burner and controller assembly as set forth in claim 10 wherein the thermocouple has a sensing element receivable in a well mounted to a water heater tank.

12. A burner and controller assembly as set forth in claim 2 wherein the temperature sensor has a sensing element adapted to be mounted to engage an exterior surface of a water tank.

13. A burner and controller assembly as set forth in claim 12 wherein the sensing element includes a bimetallic junction.

14. A method of making a water heater, said method comprising:
forming a modular heater assembly by:
attaching a heater to a base;
attaching a control unit to the base and associating the control unit to the heater to control energy input to the heater;
connecting a control circuit to the control unit, said control circuit being operable to provide a control signal to the control unit;
connecting at least one temperature sensor to the control circuit to form a portion thereof; and thereafter:
mounting a water tank assembly in heat transfer relationship to the heater; and
positioning said temperature sensor in a position to provide an output indicative of temperature of water in the water tank assembly.

15. The method as set forth in claim 14 wherein the temperature sensor provides an electrical signal.

16. The method as set forth in claim 15 wherein the temperature sensor includes a thermocouple providing an electrical current.

17. The method as set forth in claim 14 wherein said control unit includes a valve to control flow of fuel from a fuel inlet to a fuel outlet and, the method step of associating the control unit to a heater includes connecting the fuel outlet to a burner assembly.

18. The method as set forth in claim 17 wherein the at least one temperature sensor includes a first temperature sensor and the burner assembly includes a pilot and the method further includes positioning the first sensor in a position adjacent the pilot to sense a pilot flame.

19. The method as set forth in claim 17 wherein the at least one temperature sensor includes a second temperature sensor mounted in heat transfer relationship to the tank assembly and connected to components of the control circuit.

20. The method a set forth in claim 19 including the step of mounting the second temperature sensor to the tank assembly after the tank assembly is mounted to the modular heater assembly.

21. The method as set froth in claim 19 including the step of mounting the second temperature sensor to the tank assembly before the tank assembly is mounted to the modular heater assembly.

22. The method as set forth in claim 21 including connecting the second temperature sensor to components of the control circuit after the step of mounting the second temperature sensor to the tank assembly.
